(19) United States
(12) Patent Application Publication
(10) Pub. No.: US 2003/0018503 A1
(43) Pub. Date: Jan. 23, 2003

(54) Computer-based system and method for monitoring the profitability of a manufacturing plant

(76) Inventor: Ronald F. Shulman, Toronto (CA)

Correspondence Address: OGILVY RENAULT, 1981 MCGILL COLLEGE AVENUE, SUITE 1600, MONTREAL, QC, H3A2Y3, CA

(21) Appl. No.: 09/907,812

(22) Filed: Jul. 19, 2001

(51) Int. Cl. G06F 17/60

(52) U.S. Cl. 705/7

(57) ABSTRACT

The present invention relates to a system and method for monitoring the profitability of an entity, such as a manufacturing plant for example. One embodiment of the present invention relates to a computer-based method of monitoring the profitability of a manufacturing plant comprising the steps of storing system setup data in a database, receiving input data associated with multiple time periods from at least one data source, calculating profitability measures from the system setup data and input data, and outputting the profitability measures to a user. In another embodiment of the present invention, the present invention relates a method of scenario-based analysis, where projected performance measures associated with one or more proposed changes in production period are calculated and reported to the user. The present invention may be regarded as a comprehensive intelligence system and method based on a time-based model which may be used to assess an entity's profitability, and which links supply chain, sales, and marketing data to an entity's customers.

### FIELD OF THE INVENTION

The present invention relates to a system and method for monitoring the profitability of an entity, and is more particularly concerned with a computer-based system and method for monitoring the profitability of a product-producing manufacturing plant.

### BACKGROUND OF THE INVENTION

Manufacturing facilities must cope with both significant levels of complexity as well as variety. For example, manufacturing facilities typically accommodate:

(1) the production of a wide range of products;

(2) the utilization of multiple production lines;

(3) a vast diversity of bills of materials (a single finished product may contain several piece parts) that often have several operational options such as different viscosities, densities, and packaging elements;

(4) a wide range of orders for various products; and

(5) a variety of customers with different specific requirements and expectations.

Determining the profitability of a manufacturing facility has always been important, but with shrinking margins and the development of business-to-business exchanges (e.g. via the Internet), this aspect of profitability management has become increasingly critical.

The traditional business model used by many manufacturing organizations to assess a facility's profitability is based on principles of cost accounting. Fundamental financial measures of product success are still largely driven by this traditional approach where different groups and different functions within a facility are rewarded in a manner that may create conflict.

Traditional models based on cost accounting principles may suffer from a number of disadvantages and problems. For example, measurement systems used in traditional models may range from inadequate to incomplete, in that they use a static cost accounting philosophy that creates standards for cost, run times, scrap rates, and other aspects of the manufacturing process. These standards often become outdated and unrealistic over time, and may be out of line by as much as 150% or more.

Furthermore, some cost accounting systems may be so complex that users in management do not understand the drivers of those systems, or do not believe that the information used by those systems is correct. This may result in a general skepticism over what gets counted and how it is used. Consequently, a large number of hours may be wasted in negotiating standards between business units. This may also prevent a quick response to changing conditions in the marketplace and generally, to changing conditions in the competitive environment.

Still further, some cost accounting systems create an artificial separation between the business supply chain and the commercial side of the business (e.g. sales and marketing), and ignore the fact that the processes relating to product sales and product manufacture are closely inter-related.

Still further, many manufacturing plants are set up as cost centers, driven by the unit cost of each product manufactured. By focusing on costs rather than profitability, decisions made under the traditional model may not always be of the greatest benefit to an organization's profitability.

Still further, under the traditional model, depreciation of a specific machine is often charged against those products that use that machine. As a result, a product produced in an old, paid-off machine often appears cheaper than a product produced in a new machine, which may be misleading.

Still further, under the traditional model, an organization's marketing department is often directed to only sell products that exceed a certain margin. However, by focusing on margin, adverse effects relating to increased manufacturing costs may be ignored. For instance, a product can have an 80% margin, but production of the product may be driving manufacturing costs of the product to unacceptably high levels, because of poor cycle time associated with the production of the product.

Still further, the profitability of an organization's research and development (R&D) department may be measured based on a proposed product's performance and margin, and not on manufacturability. This ignores the fact that a good product that cannot be efficiently or properly produced by a manufacturing facility is usually of little value.

Thus, traditional models based on cost accounting principles are often static and internally-focused, and may be incapable of rapid adaptation. Accordingly, there is a need for an improved system and method which may be used to better assess the profitability of an entity such as a manufacturing facility, and which overcomes at least some of the disadvantages of these traditional models.

### SUMMARY OF THE INVENTION

The present invention relates to a computer-based system and method for monitoring the profitability of a product-producing manufacturing plant.

In one aspect of the present invention, the present invention relates to a computer-based method of monitoring the profitability of a manufacturing plant comprising the steps of: storing a first plurality of data items in one or more system databases, the first plurality of data items comprising system setup data; receiving a second plurality of data items from at least one data source, the second plurality of data items comprising input data associated with a plurality of time periods; calculating a plurality of profitability measures from the first and second plurality of data items; and outputting the plurality of profitability measures to a user.

In another aspect of the present invention, the present invention relates to a computer-based method of monitoring the profitability of a manufacturing plant further comprising the steps of: retrieving actual production data from a specified period; obtaining scenario data from the user, wherein the scenario data comprises data items associated with one or more proposed changes in production; calculating a plurality of projected performance measures associated with the one or more proposed changes in production; and outputting one or more of the plurality of projected performance measures to the user.

In another aspect of the present invention, the present invention relates to a computer-based method of monitoring the profitability of a manufacturing plant further comprising the steps of: receiving as input from the user one or more measures of incremental conversion costs associated with at least one of the proposed changes in production; calculating an incremental contribution to gross margin, and outputting a measure of projected gross margin to a user.

In another aspect of the present invention, the present invention relates to a computer-based method of monitoring the profitability of a manufacturing plant further comprising the steps of: calculating a net incremental revenue and outputting said net incremental revenue to a user.

In another aspect of the present invention, the present invention relates to a computer-based method of monitoring the profitability of a manufacturing plant comprising the steps of: calculating historical values from a first and second plurality of data items, wherein the historical values comprise the values of a plurality of user-specified measures associated with one or more historical periods; and forecasting future values based on the historical values, wherein the future values comprise the values of a plurality of user-specified measures associated with one or more future periods.

In another aspect of the invention, the present invention relates to a computer-based method of monitoring the profitability of a manufacturing plant comprising the steps of: calculating from a first and second plurality of data items, a measure of maximum planned throughput for a piece of equipment; and comparing the measure of maximum planned throughput to current production levels and/or current sales levels to indicate the presence of a bottleneck and/or a potential bottleneck to the user.

In another aspect of the invention, the present invention relates to a computer-based method of monitoring the profitability of a manufacturing plant comprising the step of generating one or more reports to a user, based on a first and second plurality of data items.

In another aspect of the present invention, the present invention relates to a system for monitoring the profitability of a manufacturing plant in which an embodiment of a method of the present invention is performed.

In another aspect of the present invention, the present invention relates to a computer-readable medium comprising instructions for executing the steps in an embodiment of a method of the present invention.

The present invention is directed to a system and method for monitoring the real-time profitability of an entity, and in particular, product-producing manufacturing plants. The present invention permits users to perform “what-if” scenario analyses to rethink pricing strategies, capital allocation priorities and asset utilization.

Advantageously, the present invention takes into account the time it takes for a product to be produced. For example, when a user is looking at options with respect to which products of a number of proposed products to produce, the user can analyze the time-based profitability of the products rather than solely relying on traditional margin analysis.

Furthermore, the present invention may be regarded as a comprehensive manufacturing intelligence system and method which links supply chain, sales, and marketing data to customers, using a time-based model that overcomes at least some of the problems with existing models based on traditional cost accounting methods, to assess an entity's profitability.

### BRIEF DESCRIPTION OF THE DRAWINGS

For a better understanding of the present invention, and to show more clearly how it may be carried into effect, reference will now be made, by way of example, to the accompanying drawings which show preferred embodiments of the present invention, and in which:

FIG. 1A is a schematic diagram illustrating the hierarchy of manufacturing levels in a typical manufacturing organization;

FIG. 1B is a schematic diagram illustrating the functional elements of a typical manufacturing organization;

FIG. 2 is a schematic diagram illustrating an embodiment of a system for monitoring the profitability of a manufacturing plant in a manufacturing organization;

FIG. 3A and FIG. 3B are flowcharts illustrating the steps of a method of monitoring the profitability of a manufacturing plant in accordance with an embodiment of the present invention;

FIG. 4 is a flowchart illustrating the steps of a method of analyzing the future profitability of a manufacturing plant using scenario-based analysis in accordance with an embodiment of the present invention;

FIG. 5 is a flowchart illustrating the steps of a method of forecasting user-specified measures associated with one or more future periods in accordance with an embodiment of the present invention;

FIG. 6 is a flowchart illustrating the steps of a method of determining bottlenecks and capacity-limiting resources in accordance with an embodiment of the present invention; and

FIGS. 7 through 13E are examples of screens illustrating sample output of the system for monitoring the profitability of an entity in accordance with an embodiment of the present invention.

### DETAILED DESCRIPTION OF THE PREFERRED EMBODIMENTS

The present invention relates to a system and method for monitoring the profitability of an entity, and is more particularly concerned with a computer-based system and method for monitoring the profitability of a product-producing manufacturing plant.

The present invention facilitates the monitoring of the real-time profitability of a manufacturing plant, and in a preferred embodiment of the present invention, permits users to perform “what-if” scenario analyses to rethink pricing strategies, capital allocation priorities and asset utilization. The present invention may be regarded as a comprehensive manufacturing intelligence system and method which links supply chain, sales, and marketing data to customers, which takes into account the time it takes for products to be produced.

The present invention provides a linkage between diagnosis and remediation (i.e. by allowing a user to view actuals against standards), allows benchmarks to be established, and permits performance to be tracked against those benchmarks. For example, a benchmark can be created by capturing data and determining the average time it takes to produce a product. The user may also capture setup times and down times to use in benchmarking.

The present invention measures a series of key variables that drive decision velocity (i.e. making intelligent decisions based on true profitability) and thus ultimately profitability. The present invention also facilitates a dynamic review of the changing context in which an organization operates. These measures can be analyzed at a variety of levels within the organization.

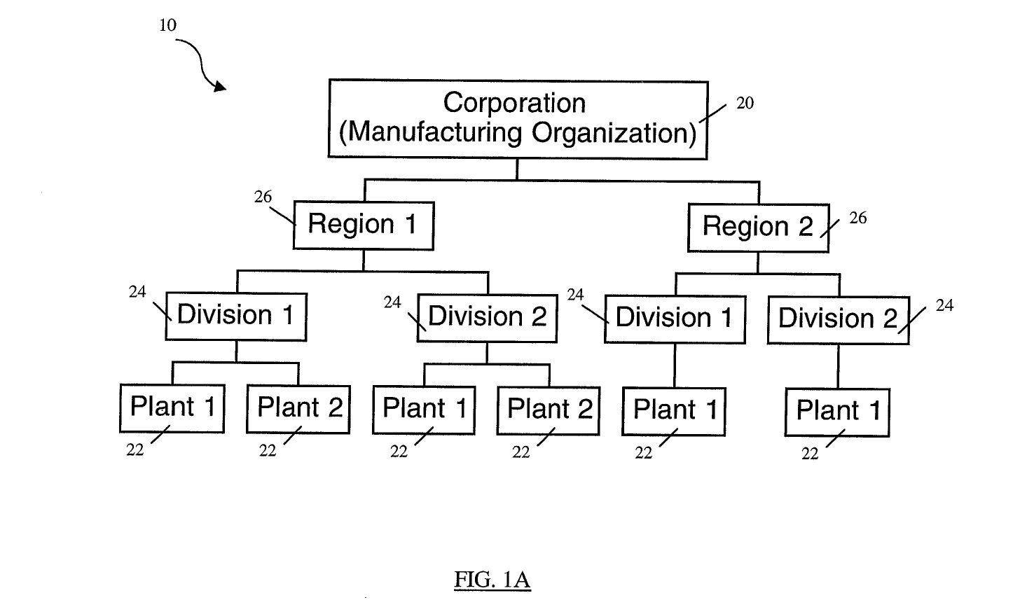

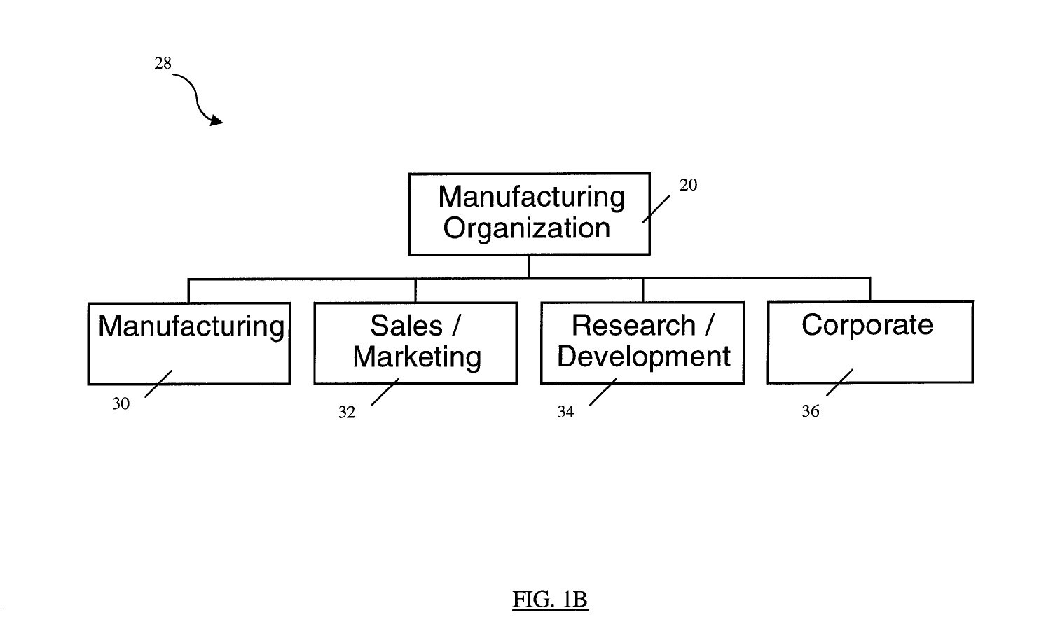

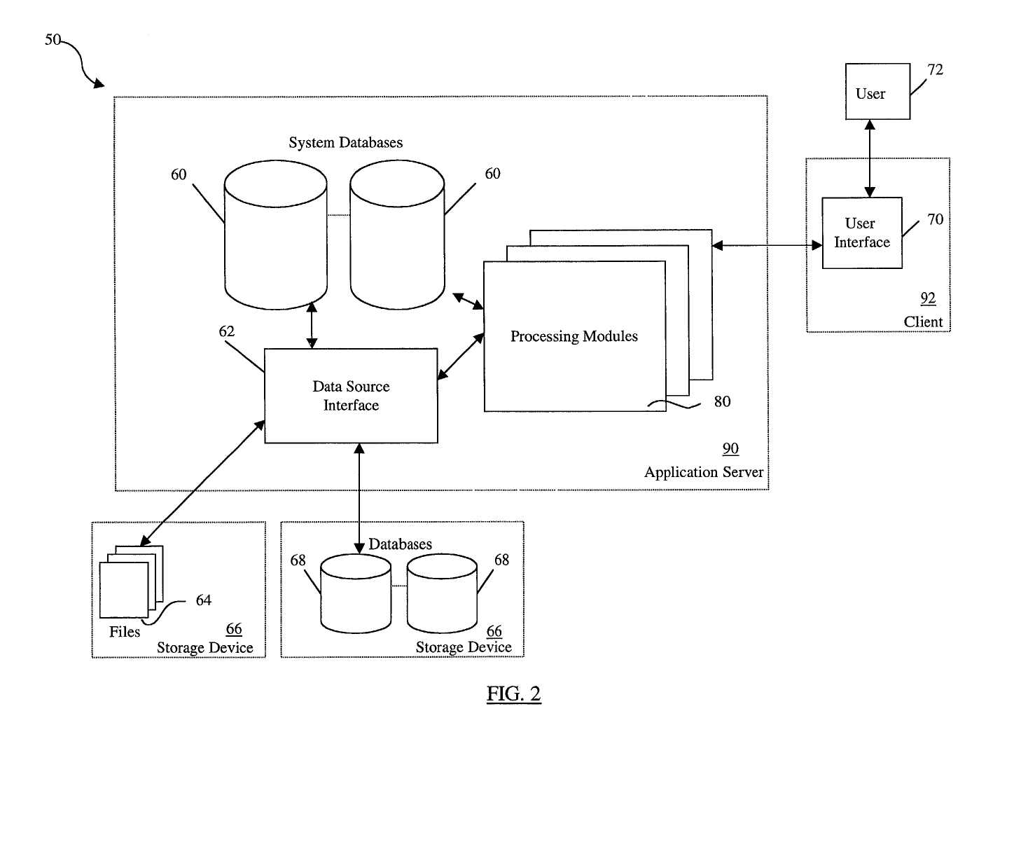

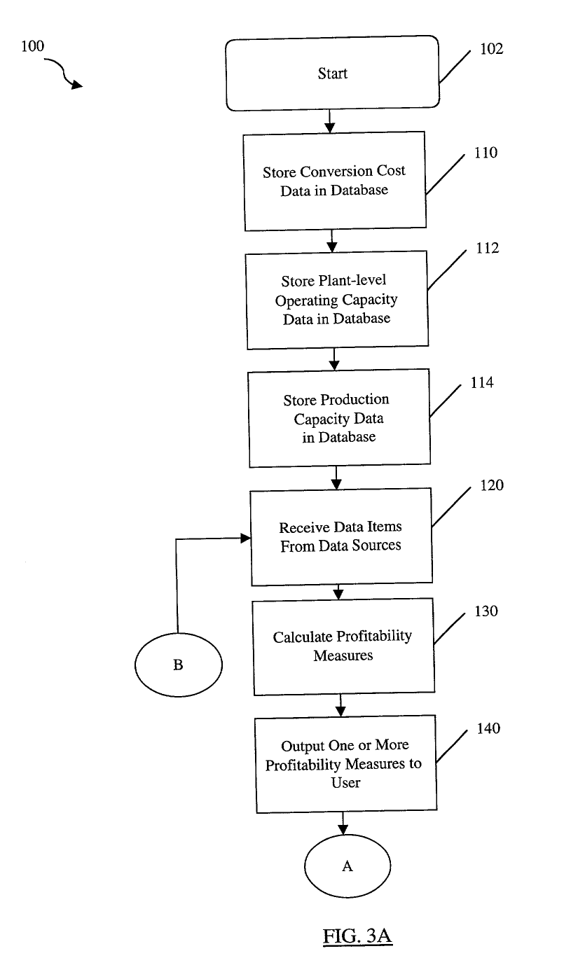

Referring to FIG. 1A, a schematic diagram illustrating the hierarchy of manufacturing levels in a typical manufacturing organization is shown. The typical manufacturing organization is shown generally as 10. The typical manufacturing organization may exist as a corporation 20. The corporation 20 operates a series of plants 22 which may be categorized by divisions 24 based on the types of products produced by the plants 22, and may be further grouped into regions 26 based on the geographical location of the plants 22, for example. However, the above example is illustrative of only one manufacturing organizational structure; more or less levels may be present in different organizations or entities.

Referring to FIG. 1B, a schematic diagram illustrating the functional elements of a typical manufacturing organization is shown generally as 28. The corporation 20 will also typically comprise other components such as a manufacturing department 30, a sales and marketing department 32, a research and development (R&D) department 34, and a corporate management department 36. The manufacturing department 30 performs tasks relating to the production of products for a corporation 20. This is typically done through the manufacturing facilities (e.g. plants 22) of a corporation 20, which typically have the highest asset base in a corporation 20. The compensation of employees of departments directly involved in the manufacturing of products (including, for example, in packaging departments [not shown]) are traditionally measured based on product margin. Sales and marketing department 32 performs tasks relating to the marketing and sales of products produced by the corporation 20, and traditionally relies upon measures relating to sales margin in determining compensation of its employees. R&D department 34 performs tasks relating to the development of new products, and traditionally rewards its employees based on their ability to develop products that have a high margin. Corporate management department 36 handles administrative matters relating to the corporation 20 and traditionally uses cost accounting methods to assess the profitability of the corporation 20. Different organizations may be comprised of different functional elements, or more or less functional elements than those described above.

The functions of one or more functional elements of FIG. 1B may be performed by employees at one or more organizational levels of the corporation 20 as shown in FIG. 1A.

Advantageously, the time-based profitability model upon which the present invention is based treats each manufacturing facility or plant in the manufacturing organization as a revenue engine. By thinking about the plants not as cost centers but as profit centers, an organization can develop strategies to drive as much revenue as possible through the plants, allowing an organization's Return on Net Assets (RONA) and Economic Value Added (EVA) for example, to be improved.

By focusing on the profitability of each plant in the system rather than just their cost, an organization will make very different decisions. These decisions may ultimately help marketing to generate greater sales with greater profits, provide R&D departments with measures that will evaluate new product manufacturability thus dramatically improving quality and real profit on new ventures, provide the manufacturing elements of an organization with a set of measures that focus on RONA and EVA, help Finance departments to develop economic forecasts, and allow for real-time accurate recording of manufacturing times, using mobile commerce tools (handheld devices) and techniques for instance.

Most plants will have a number of manufacturing production lines. Each production line may be comprised of one or more cells, which is a component of a production line characterized by a single process of manufacture (i.e. where one or more steps in producing a product on the production line are performed). Under the model upon which the present invention is based, each production line in turn is not a cost center but also a revenue engine. The present invention facilitates the measurement of the utilization of a production line, by calculating profitability measures such as Actual Productive Uptime (APU™), Target Productive Uptime (TPU™), and Product Profit Velocity (PPV™). The present invention also permits a user to forecast what percentage of cost and profit the production line must carry to ensure that a specified business plan (e.g. a forecast of what the company will sell for the next quarter or year) is made. The present invention uses data of previous years to provide the user with an indication of how much revenue the production line produced last year. For each production line, the previous years' revenue analysis can be broken down to show APU™ for the production line in the previous year, TPU™ for the production line in the previous year, and the actual PPV™ for each product along with each of its key measures—selling price, raw material costs, volume, cycle time, $/hr. This data can also be analyzed by a user in aggregate form. The present invention also facilitates the calculation of the cost per hour for operating each production line, thus providing net revenue per hour. The user may then create scenarios that manipulate both the APU™ (actual productive uptime) and the PPV™ (product profit velocity) for the planning year to meet the new sales target created during the forecasting process. The present invention will also provide an assessment of how much uptime and what PPV™ are required to make a financial target on the business plan (e.g. Profit Target Hurdle Rate or PTHR™).

Advantageously, the present invention, provides means to link data relating to the supply chain (e.g. production supplies) to the sales and marketing department. This is accomplished by facilitating the real-time pricing of products for example, which may result in greater flexibility and greater profits, assist with general pricing strategies, and allow for instant analysis of “what-if” type scenarios.

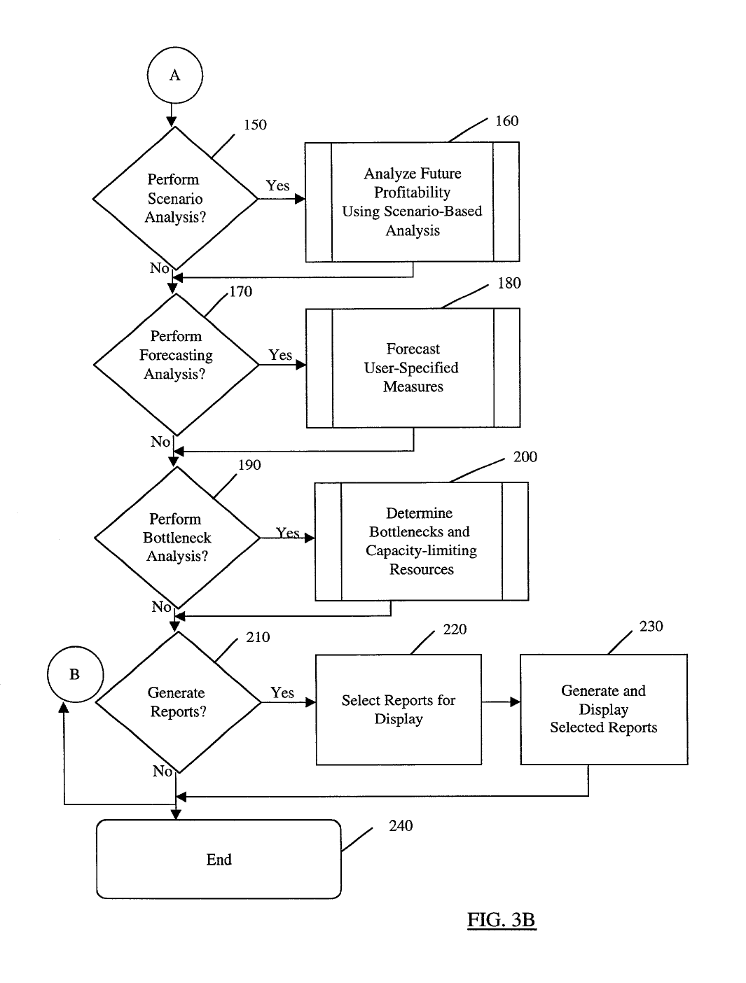

Referring to FIG. 2, an embodiment of a system for monitoring the profitability of manufacturing plant in a manufacturing organization is shown generally as 50. System 50 comprises one or more system databases 60, a data source interface 62, a user interface 70, and one or more processing modules 80. The databases 60, data source interface 62, and processing modules 80 may reside on an application server 90, while the user interface 70 may reside on a client computing device 92, although other configurations of the system 50 are possible. As one skilled in the art will recognize, any of the components of system 50 may be distributed across a plurality of computing systems as chosen by the implementer for performance, security, robustness, or other reasons.

In this embodiment of the invention, system databases 60 are used to store input data originating from one or more data sources to be used by components of the system 50. The input data may originate from one or more files 64 stored on a local or remote storage device 66, or from one or more local or remote databases 68, for example. The input data may then be received for storage in the system databases 60 through the data source interface 62. Input data may also originate from a user 72, entered through the user interface 70.

Processing modules 80 of system 50 are programmed to implement one or more of the methods of an embodiment of the present invention. In variant embodiments of the invention, instructions that embody one or more of the methods of an embodiment of the present invention may also be stored on a computer-readable medium.

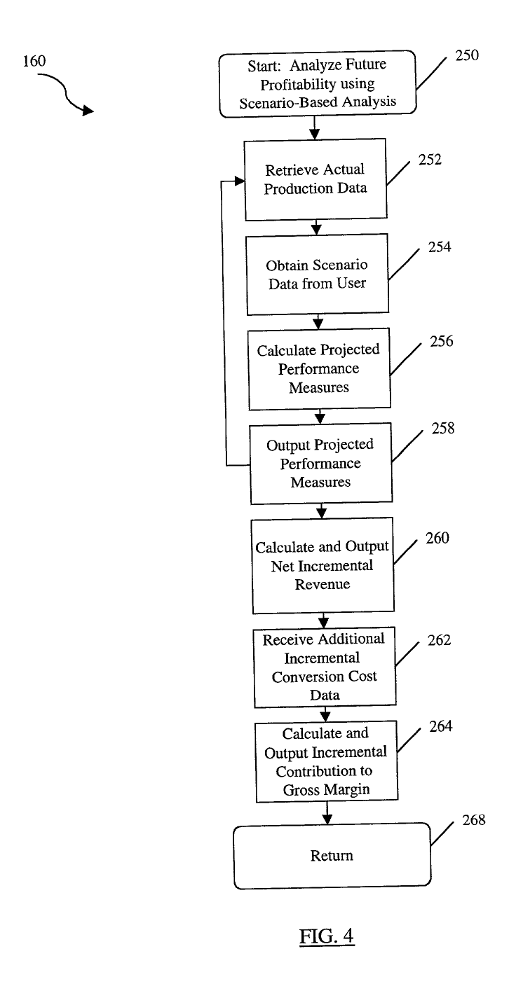

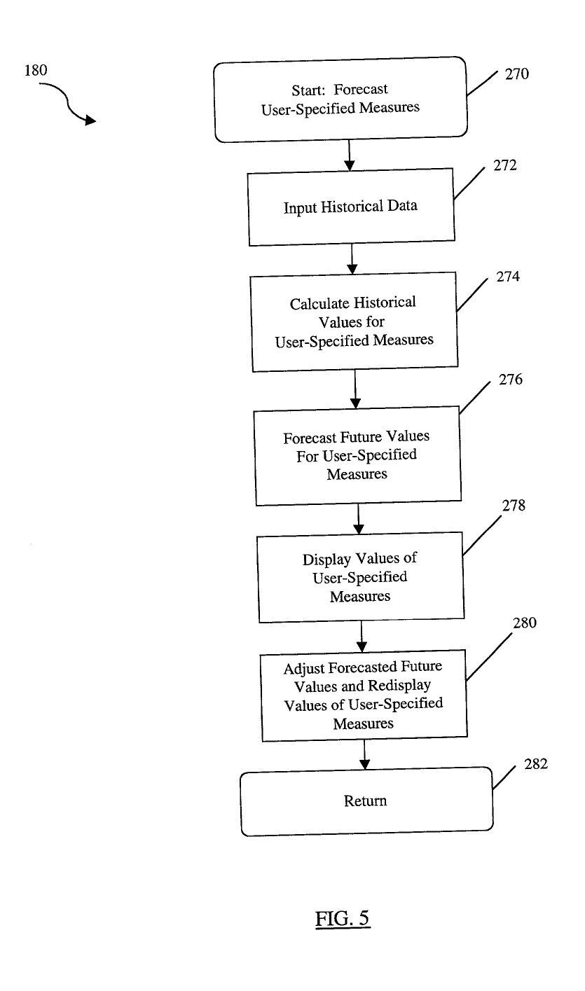

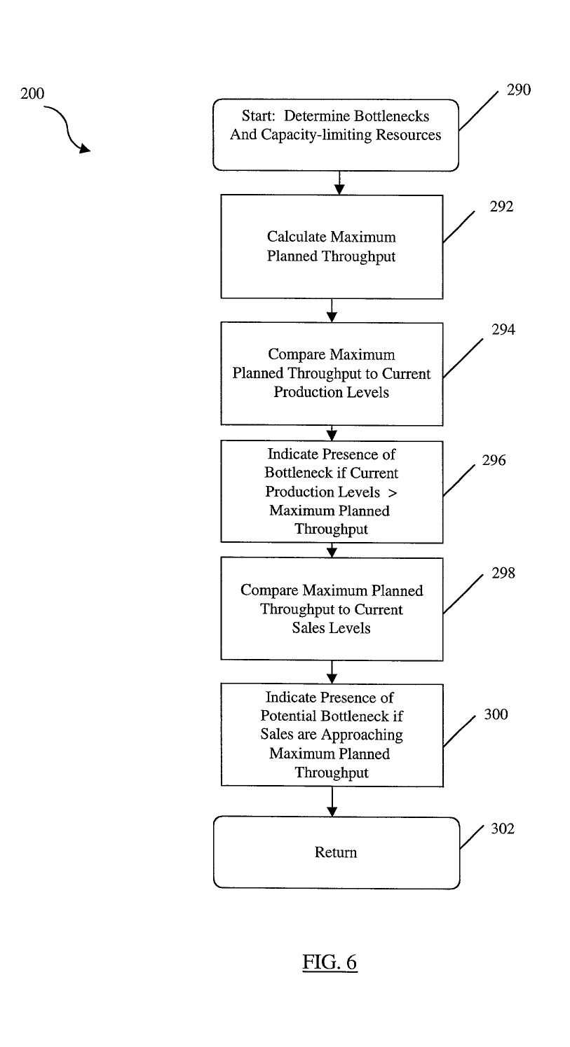

Referring to FIG. 3A, a method of monitoring the profitability of a manufacturing plant in accordance with an embodiment of the present invention is shown generally as 100 and commences at step 102.

At steps 110, 112, and 114, a first set of data items is stored in system databases 60. The first set of data items comprises system setup data, which may include, for example, conversion cost data, production line capacity data, and plant-level operating capacity data. This data is used to populate the system databases 60 with information on one or more plants of the manufacturing organization. The first set of data items may be input by a user through a user interface 70, or retrieved from some other data source through data source interface 62.

More specifically, at step 110, conversion cost data is stored in system databases 60. The conversion cost data may include estimated or expected cost data relating to various costs likely to be incurred by plants in a corporation. The conversion cost data may include, for example, direct labor cost data (e.g. the projected cost of labor to operate the plant), indirect support labor cost data (e.g. any estimated variable labor cost), indirect maintenance cost data (e.g. any additional maintenance cost associated with increasing production), salaried labor cost data (e.g. estimated total cost of salaried personnel), depreciation cost data (e.g. cost of write-offs the corporation 20 is going to classify as a depreciation charge for a specific plant), power consumption cost data (e.g. expected power costs), freight cost data (e.g. total estimated expenses related to shipping), and other cost data. Separate sets of conversion cost data, either input or calculated, may be determined at both the plant level and production line level.

At step 112, plant-level operating capacity data is stored in system databases 60. The operating capacity data may include, for example, a planned available production time, and an indication of how the plant's available production time may be affected by other factors, such as scheduled downtime for maintenance and setup. The planned available production time is calculated in hours, from an indication of the number of hours per day that a plant is expected to be operational, an indication of the number of days per week that a plant is expected to be operational, and an indication of the number of weeks per planning period that a plant is expected to be operational. The planned available production time, in hours, will typically be the product of these three indications (assuming they are non-zero), with a reduction factor applied to the product. The reduction factor accounts for the other factors that affect a plant's planned available production time such as schedule downtime for maintenance and setup. Typically, the planning period will be one year, and more specifically, will usually be the organization's fiscal year. However, other planning periods may be used. The planned available production time will typically be less than the maximum theoretically available production time, which is often based on a 24 hours per day, 7 days per week, 52 week planning period.

At step 114, production line capacity data is stored in system databases 60. The production line capacity data includes data related to specific production lines. This may include, for example, an indication of the number of production lines being monitored, and other production line-specific constraint data. Other production line-specific constraint data may include, for example, production speed data (i.e. how fast a particular product may be produced on a given production line), equipment availability data (i.e. factors that may affect the available productive time of a production line, such as the use of a shared input line or different amount of required maintenance for different pieces of equipment used on the production line, for example), and external constraints data (e.g. environmental constraints, legal constraints). A remarks field or record containing an explanation of the nature of a specific constraint on a production line may also be provided.

At step 120, a second set of data items is received from one or more data sources. A data source may be a user through a user interface 70, or some other data source such as a database, a data stream, data files, or a computer-readable medium for example, through a data source interface 62. The second set of data items includes input data associated with a series of time periods. Typically, the second set of data items will represent monthly data for the last fiscal or financial year, as well as monthly data for the current year. The second set of data items may include, for example, customer data (e.g. a listing of all active customers), product data (e.g. a listing of all currently produced products), production data (e.g. actual data on what was produced in a previous period), sales data (e.g. a listing of all sales in a previous period), and profit/loss (P&L) data (e.g. actual conversion costs incurred). A user may also enter a measure of target profit to be considered in calculating profitability measures, and used in conjunction with other features of the system 50.

Examples of the data fields used to store data items that may be received at step 120, may include the following:

Plant ID—This is the plant that produced the product identifier.

Customer ID—This is used in the system to identify customers.

Customer Name—This is the name of the customer, and may be used in reports.

Sales Type—This is used to determine if the sale was internal or external. Different type of sales are processed differently.

External—All revenue is credited to the producing and selling plant.

Internal—90% of weighted average price is credited to the producing plant. The selling plant gets all sales revenue less 90% of weighted average price.

Min blank—This is the manufacturing name for the product.

Zsld—This is the sales name for the product. A single manufacturing product may be sold under several different names due to customer or packaging requirements.

Line ID—This is the production line that made this product.

Average Cost—This is the average material cost to produce this product.

Standard Cost—This is the average cost to produce the product including material and conversion.

Average Price—This is the weighted average price that the product was sold for.

Bunit—This is the product line that the product belongs to.

Pspeed—This is the standard rate of how may products may be produced in one hour (speed of manufacturing).

Pqty—This is the quantity that was produced in the last month.

Sqty—This is the quantity that was sold.

Smonth—This is the month in which the sale took place.

Syear—This is the year in which the sale took place.

aLabor—This is the Year-to-date (YTD) total labor cost to operate the plant.

aDepreciation—This is the YTD depreciation that has been charged to the plant.

afreight—This is the actual YTD freight costs incurred by the plant.

aOther—This is the actual YTD other costs incurred by the plant.

The above data fields are provided only by way of example; different data fields may be used in different implementations and embodiments of the present invention.

At step 130, a set of profitability measures are calculated using data items in the first and second set of data items obtained in earlier steps of method 100. Most of these profitability measures are time-dependent in that the measures take into account the time it takes for products to be produced in the manufacturing plant. These profitability measures may include, for example, the following:

Product Profit Velocity (PPV™)

To do this calculation, the following data on each sale of a selected product is retrieved:

The plant which produced the product.

Sales product ID.

Production product ID.

Pspeed, the # of kilos of a product that are produced per hour including set up time.

Production line ID.

Material Cost, the cost of the raw materials necessary to produce the product.

Sales Quantity in kilos.

The price per kilo that the product is sold at.

The following sub-calculations are then made:

1) Total Revenue=Sales Quantity x Price

2) Total Material Cost=Sales Quantity x Material Cost

3) Total Time in hours=Sales Quantity/Pspeed

Finally, the Product Profit Velocity in Dollars per Hours is calculated:

$$Product Profit Velocity = \frac{Total Revenue - Total Material Cost}{Total Time}$$

By utilizing the Product Profit Velocity in Dollars per Hour you can gain a competitive advantage for a product based on its manufacturability, as determined by its relative $/hr measure (i.e. the product's profit velocity).

Consider the following example, which serves to illustrate why the rate at which money is made may be more important than the percentage profit on a single item. Suppose Product A costs $100 to produce and sells for $400 and thus has a 75% margin ((400−100)/400), whereas Product B costs $100 to produce and sells for $200 and thus only has a 50% margin ((200−100)/200). At first glance, it appears that the more desirable product is Product A. But when the time to produce the product is taken into account, the profitability of product A may be put into question. Suppose that Product A takes 4 hours to make, giving a contribution per hour of $75 ((400−100)/4), and Product B takes 1 hour to make, giving a contribution per hour of $100 ((200−100)/1). In this example, incorporating the time it takes to produce the products in a profitability assessment suggests that Product B is the better choice when manufacturing resources are limited.

Actual Productive Uptime (APU™)

APU™ is a particularly important measure in evaluating profitability. APU is a measure of plant utilization. It is the amount of time a production line is producing quality product in relation to the number of shifts the plant is running. APU might be based upon 3 shifts per day, 5 days per week over 48 weeks. APU can be compared to a production line's target productive uptime (TPU™), which is the amount of time (e.g. in hours) the production line is potentially available (e.g. planned available production time). APU is usually determined from the plant-level operating capacity data obtained at step 112, as well as from any data relating to constraints on the specified production line, as obtained at step 114. The processing modules 80 will calculate both the previous years APU and TPU once the system databases 60 have been populated with the requisite data. This provides an analysis of the available profit that could have been earned if plant utilization had been higher by calculating the Total Profit Opportunity (TPO™) for a production line (which can subsequently be aggregated to obtain a value at the plant level). For example, if the average Product Profit Velocity is $400 per hour, and the utilization of a production line can be increased by 500 hours per year, then the Total Profit Opportunity is $200,000 since an additional $200,000 of profit can be generated with very little increase in cost.

Measures such as APU, TPU and TPO can be used in planning strategies to try and drive the APU significantly higher (e.g. 15-20%) for the planning year over the previous year's APU, by adding a new product or increasing production and sales of an existing product to a production line, for example. Scenario-based analysis (as will be described later with reference to FIG. 4) may be used to test the desirability of such production changes.

The Actual Productive Uptime is the total hours of operation for a year for each piece of equipment summed at the plant level.

To do this calculation, the following data on each plant for each product of each production line is retrieved:

The plant ID is used to determine what plant we are working with.

Production product ID and production line ID.

Production month.

Production year.

Production time.

The total quantity of the product produced on each specified line that month.

The Total Use (e.g. in hours) of the plant is determined by summing the total production time for each piece of equipment for each product produced, or:

Total Use=the sum of all time spent by each production line in a plant producing quality product.

The Actual Productive Uptime can then be calculated as follows: Actual Productive Uptime=Total Use/TPU.

Calculating Actual Productive Uptime allows a user to perform a capacity analysis by assessing how a production line, or a group of production lines, are performing, as compared to a user-defined benchmark or historical APU values, for example.

Profit Target Hurdle Rate (PTHR™)

A product's Financial Hurdle Rate is the minimum Product Profit Velocity in Dollars per Hour that must be generated for a product to be profitable. In other words, it represents a break-even point that must be achieved in order for a product to be profitable. A Profit Target Hurdle Rate (PTHR™) further takes into account a target profit. In other words, PTHR is the minimum Product Profit Velocity in Dollars per Hour that must be generated for a product to achieve a specified target profit.

To calculate a plant's Profit Target Hurdle Rate, the following data is retrieved for a specified plant:

The Plant ID is used to determine what plant we are working with.

The total annually budgeted labor cost.

The total annually budgeted depreciation.

The total annually budgeted power expense.

The total annually budgeted freight expense.

All other costs that will be charged to the plant.

A specified target profit ($).

The Profit Target Hurdle Rate is determined by the sum of all costs allocated to the plant plus the specified target profit, divided by the planned available productive uptime (which also takes into account plant-level maintenance and setup time).

Financial Throughput (FT™)

The Financial Throughput for a plant can be defined as the total revenue less the cost of raw materials (i.e. material cost) attributed to sales of a given product. Alternatively, by dividing the total revenue and material cost by the total quantity of a product sold (e.g. in a specified period), a per unit measure of Financial Throughput can be calculated, equal to the weighted average price of a product minus the material cost of the product.

To calculate Financial Throughput, the following data is retrieved for each batch of a specified product produced:

The plant which produced the product.

Production product ID.

The line on which the product is produced.

The cost of the raw materials necessary to produce the product.

Sales quantity and sales price for a specified period.

With respect to the former formulation of Financial Throughput, the following sub-calculations are made for each product and may be summed over all the products produced in the plant to obtain totals:

1) Average Price is the weighted average price a product is sold at.

2) Total Revenue=Sales Quantity×Average Price.

3) Total Material Cost=Sales Quantity×Material Cost.

Financial Throughput is then calculated as follows:

Financial Throughput=Total Revenue−Total Material Cost

In the latter formulation of Financial Throughput, we can divide the above amount by the sales quantity to obtain a Financial Throughput measure per unit (e.g. kg) of product. This can subsequently used to calculate a measure of the dollars per hour that a specified product produced by one or more production lines generates (i.e. PPV), by multiplying the per unit measure of Financial Throughput by the speed at which the product can be produced (i.e. Pspeed).

Composite Profitability Measures

To calculate a composite profitability measure, any defined mathematical function of the above measures may be evaluated by the system 50, at step 130.

Referring again to FIG. 3A, at step 140, one or more of the profitability measures may be output to the user through user interface 70, at the option of the user. The profitability measures may be displayed, for example, in tabular form along with other data items and/or performance measures.

The steps in the method commencing on FIG. 3A continue on FIG. 3B.

In accordance with an embodiment of the present invention, the present invention advantageously also facilitates analysis of incremental business or production through the creation of scenarios. At step 150, the user may choose to perform a scenario analysis. If a scenario analysis is desired, the flow of method steps proceeds to step 160, at which steps are performed to analyze the future profitability of the plant using scenario-based analysis. Otherwise, the flow of method steps proceeds to step 170. The steps performed at step 160 are described in greater detail later in this specification, with reference to FIG. 4.

In accordance with an embodiment of the present invention, the present invention also facilitates the forecasting of user-specified measures associated with one or more future periods. At step 170, the user may choose to perform a forecasting analysis. If a forecasting analysis is desired, the flow of method steps proceeds to step 180, at which steps in the forecasting of user-specified measures associated with one or more future periods are performed. Otherwise, the flow of method steps proceeds to step 190. The steps performed at step 180 are described in greater detail later in this specification, with reference to FIG. 5.

In accordance with an embodiment of the present invention, the present invention also facilitates the determination of bottlenecks and capacity limiting resources. At step 190, the user may choose to perform a bottleneck analysis. If a bottleneck analysis is desired, the flow of method steps proceeds to step 200, at which steps are performed to determine bottlenecks and capacity limiting resources. Otherwise, the flow of method steps proceeds to step 210. The steps performed at step 200 are described in greater detail later in this specification, with reference to FIG. 6.

At step 210, the user may choose to view or print reports that may be generated by one or more processing modules 80 based on data stored in the system 50. If desired, one or more specific reports may be selected by a user for display at step 220, and at step 230, the selected reports are generated and displayed. Persons skilled in the art will recognize that a wide variety of reports may be generated from the data stored in system 50. The inventor recognizes that various implementations of the present invention will need to cater to specific user needs and generate appropriate reports. The following serves only as examples of the types of reports that may be generated by the present invention:

Production Report: A production report gives the user the ability to look at the contribution per hour by product. The report may cover all products for a company, a plant or grouping of plants, by product line, or by a single or group of products. The items in the report can be sorted by product ID or contribution per hour, as desired. This report may be very useful when a production line is constrained, and it is necessary to determine which products to continue to make and which ones to drop; conversely, when the production line is not constrained, it can be used to examine which products should be subject to increased production.

Sales Report: A sales report gives the user the ability to look at sales by customer. It may be used to quickly identify what products a customer is buying, and at what volume. Similarly, it may also be used to identify which customers are purchasing a specific product, and at what volume. The report may be generated for one or more customers or products from the entire company, a grouping of plants or a single plant or product line, for example. This report may be useful in determining the overall profitability of a customer or product.

Product Dictionary Report: This report allows the user to see the manufacturing name and all associated sales names for a product. This may be useful because the sales department and the production department may not use the same name for the same product. A single manufacturing product may be sold under different names due to differences in packaging, or even due the fact that the product was sold to different customers.

Step 240 marks the end of the method 100 of monitoring the profitability of a manufacturing plant in accordance with an embodiment of the present invention. However, prior to performing step 240, the flow of method steps may instead proceed back to step 120 at which further data items from data sources are received, as shown in FIGS. 3A and 3B, allowing the remainder of the steps of method 100 to be repeated. Furthermore, prior to performing step 240, the flow of method steps may also proceed back to step 110 if new setup data is available, or if the setup data previously entered needs to be modified [flow not shown].

Referring to FIG. 4, a flowchart illustrating a method of analyzing the future profitability of a plant in accordance with an embodiment of the present invention is shown generally as 160. Method 160 uses scenario-based analysis, and commences at step 250.

Scenario-based analysis is a method of doing a “what-if” analysis using real data to project real outcomes. Scenario-based analysis requires access to the plant's information from previous periods, typically from at least the previous fiscal year. For example, this information may include data relating to products, customers, volumes, raw material prices, selling prices, and production speed.

Scenario-based analysis may also be used as a means to perform a capacity analysis by product, for example, at the production line or the plant level. Different aspects related to the production of one or more products can be changed, reflecting different scenarios which the user wishes to analyze, and the effect of those changes on capacity-related performance or profitability measures, including APU for instance, can be determined and observed.

Scenario-based analysis allows the user to choose a group of products, or a group of customers, to rethink and replan a selling/manufacturing strategy. Advantageously, scenario-based analysis may provide a user with the ability to involve a key group of people in building or modifying a business plan using accurate information in an abbreviated manner, and with the capability to hold the key people accountable for projected outcomes.

Scenario-based analysis can be performed at any time. Scenarios can be reviewed and modified whenever a user desires, on a quarterly basis, for example.

Scenario-based analysis may be used to assess the profitability of incremental business. Incremental business is additional business to that which is already being allocated all of the fixed costs and overhead. Put another way, incremental business is profitable if it covers the variable cost of producing the product. With this in mind, a user can look objectively at how much additional contribution can be generated by manufacturing and selling an additional product or more of an existing product.

Scenario-based analysis allows the user to assess the impact of adding a new product to an existing production line, or to increase production of an existing product.

At step 252, actual production data from a specified period is retrieved from system database 60. Typically, the specified period is a prior fiscal year.

At step 254, scenario data is obtained from the user. The scenario data relates to information associated with a proposed change in production. As indicated earlier, a proposed change in production may be the addition of a new product to a specified production line, in which case the scenario data may include the price of the product, the material cost of the product, the production speed, and the production quantity. Alternatively, the proposed change in production may be an increase in production of a specified existing product, in which case the scenario data may include the price of the product and the production quantity.

At step 256, one or more projected performance measures associated with said proposed change in production can be calculated. Projected performance measures may include any measures with a value that can be tracked over time, and may also include profitability measures. For example, projected performance measures may include: production time, total sales, total material cost, financial throughput, APU, contribution margin as a percentage, and contribution dollars per hour, associated with each product being produced, at the production level or at the plant level where desired.

At step 258, one or more calculated projected performance measures are output to the user.

The output of step 258 gives the user a quick look at the overall profitability or financial throughput of adding additional production while the dollars per hour can be easily compared to the Profit Target Hurdle Rate for the plant.

Steps 252 to 258 may be repeated for additional proposed changes in production.

At step 260, the scenario data and actual production data may be used to calculate a net incremental revenue. This is the net incremental revenue generated by the increase in production. Net incremental revenue can be subsequently output to a user.

The present invention may also further facilitate the capture of other incremental costs associated with increased production of an existing product and/or the production of a new product. In addition to the additional material cost of increasing production or adding a new product, other costs are affected as well. These additional incremental conversion costs may include, for example, direct labor costs, indirect labor costs, depreciation costs, power consumption costs, one-time costs, or other costs. The user may capture all of these other costs when looking at the total effect to the plants' profitability due to the increased production.

At step 262, the system 50 may receive input data from the user relating to one or more measures of these additional incremental conversion costs associated with the proposed change(s) in production. Note that in some instances, decreases in incremental conversion costs may also be specified.

At step 264, the input data obtained at step 262 may be used to calculate the incremental contribution to gross margin (or incremental contribution to P&L) due to the additional production, and taking into account the additional incremental costs obtained at step 262. The incremental contribution to gross margin and/or the projected gross margin under the conditions of the specific scenario being analyzed can be subsequently output to the user.

Step 268 marks the end of the method 160 of analyzing the future profitability of a plant using scenario-based analysis in accordance with an embodiment of the present invention.

Referring to FIG. 5, a flowchart illustrating a method of forecasting user-specified measures associated with one or more future periods in accordance with an embodiment of the present invention is shown generally as 180. Method 180 commences at step 270.

Method 180 allows the user to view data from the company level all the way down to the plant/product line level. Future data points are then forecast based upon the number of past data points available. If there are less than 12 past data points, straight linear forecasting is performed. If there are 12 or more past data points, then seasonally adjusted forecasting (i.e. adjustments are made due to changes in data that appear to be periodic in nature) is performed with the smoothing of any anomalies. Typically, monthly data for the past 24 months is retrieved to perform the forecasting of method 180. Data used for the forecasting method is input to the system 50 at step 272. As will be recognized by persons skilled in the art, a wide variety of forecasting algorithms and techniques may be used. The inventor does not intend to preclude the use of other forecasting algorithms in an implementation of the present invention.

In variant embodiments of the invention, the user can be given the option to select how many data points to use in creating the forecast. This gives the user the ability to remove any old data that may no longer be pertinent to the current process.

At step 274, historical values of one or more user-specified measures are calculated. Such user-specified measures may include production quantity, material cost, revenue, financial throughput, freight cost, and sales quality, for example.

At step 276, forecasted future values associated with one or more future periods (e.g. months) are determined based on historical values, using either straight-line forecasting techniques, seasonally adjusted forecasting techniques, or other forecasting techniques as are known.

At step 278, historical values and forecasted future values of user-specified measures may be presented to a user in the form of a chart, a line graph, or some other form of report. The line graph gives a user a quick visual of what the current financial strength of a product line is, as well as a look at future projections. The graph can also be used to quickly identify any anomalies in the historical data, and can be used to detect and analyze trends with respect to the various user-specified measures. At step 278, the user may be provided with the facility to remove anomalies or specified sections of data after viewing the historical and forecasted values at this step. The inclusion of such a feature may be provided to certain users if the implementer of the present invention wishes to allow certain users to modify historical data used in method 180.

At step 280, the user may be provided with the facility to make adjustments to forecasted values, if desired by the implementer of the present invention, or as determined by an administrator of system 50. For example, changes to future volumes, revenues, or product prices may be made by the user. These changes may be made based on information that the sales department or corporate management may have (e.g. concerning future events in the marketplace) that may affect these values, and which may not be adequately reflected in the computer-generated forecast. Advantageously, this allows data originating from the sales and marketing department to be linked with data relating to the manufacture of products, to provide for a more accurate and complete forecast. A new forecast reflecting the user-entered changes to the previously generated forecast may then be displayed to the user in a manner similar to that provided for at step 278. This step may be repeated multiple times.

Step 282 marks the end of method 180 of forecasting user-specified measures associated with one or more future periods in accordance with an embodiment of the present invention.

Referring to FIG. 6, a flowchart illustrating a method of determining bottlenecks and capacity-limiting resources in accordance with an embodiment of the present invention is shown generally as 200. Method 200 commences at step 290. By using data on production speed, availability and constraints, system 50 can be used to determine where bottlenecks are occurring or about to occur in a plant (e.g. 22 of FIG. 1). Constraints are the physical capacity-limiting factors of the governing piece of equipment (e.g. the slowest) on a production line. For example, sometimes the constraint arises from the poor design of a plant, which forces a key piece of equipment to wait for resources between batches or product runs. The impact of these external constraints on the key resources is input into the system 50 by a user (72 of through a user interface 70, FIG. 3) with knowledge of the production line.

Planned available production time is determined by how many hours per day the line is operable, how many days per week the plant operates and how many weeks per planning period (e.g. year) the plant operates. These values are input into the system 50 by a user, typically on an annual basis. Any production line-specific constraints may also be incorporated into the determination of planned available production time.

Production Speed is the volume of a product that can be produced per hour. Production Speed may be calculated using the following formula:

Production Speed=Standard Product Batch Size/Standard Hours where Standard Hours=Standard Setup Hours+Standard Production Hours

At step 292, the planned available production time is multiplied by the Production Speed in calculating the maximum planned throughput for each piece of equipment in the plant.

At step 294, the maximum planned throughput is compared to current production levels. If current production levels are demanding more than the maximum planned throughput (maximum planned throughput=planned available production time×amount of product per hour that a machine can produce), this suggests that a bottleneck exists, the presence of which is indicated to the user at step 296.

At step 298, the maximum throughput is compared to current sales levels. If current sales levels are approaching the maximum throughput (e.g. sales cause APU to approach 100% or current sales levels are substantially equal to maximum planned throughput), this suggests that a potential bottleneck exists, the presence of which is indicated to the user at step 300.

In most cases, a piece of equipment will support several products at differing production speeds. A weighted average may be used based on the products that are produced by a specific piece of equipment.

Step 302 marks the end of method 200 of determining bottlenecks and capacity-limiting resources in accordance with an embodiment of the present invention.

By analyzing the comments or remarks pertaining to the known constraints which may have been entered at setup, and reviewing known and potential bottlenecks, the user can make intelligent decisions on plant improvements.

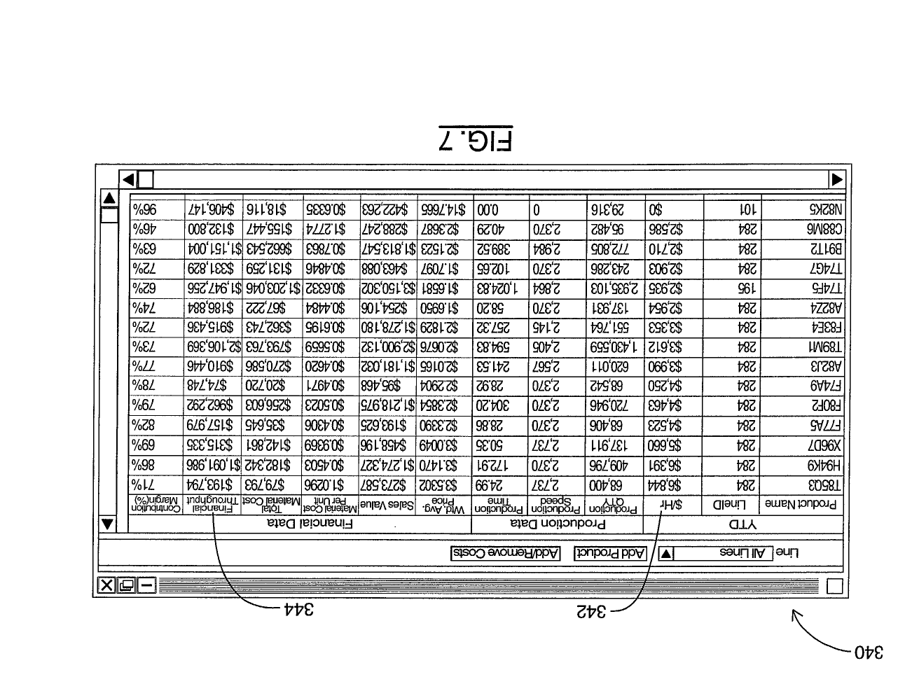

Referring to FIGS. 7 through 13E, example of screens illustrating sample output of the system 50 are shown.

Referring to FIG. 7, a screen capture displaying profitability measures for products is shown generally as 340. Screen 340 may be generated at step 140 of FIG. 3A. A number of profitability measures are displayed, including measures of product profit velocity 342 and financial throughput 344.

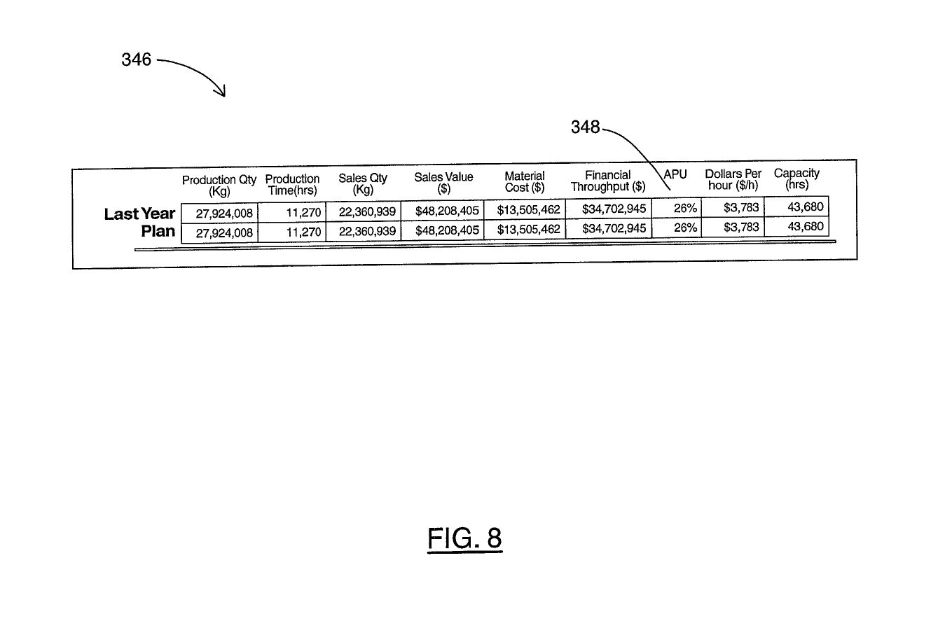

Referring to FIG. 8, a screen capture displaying plant-level data relating to actual and planned production is shown generally as 346. Screen 346 may also be generated at step 140 of FIG. 3A. Profitability measures can be displayed, including APU 348 for example.

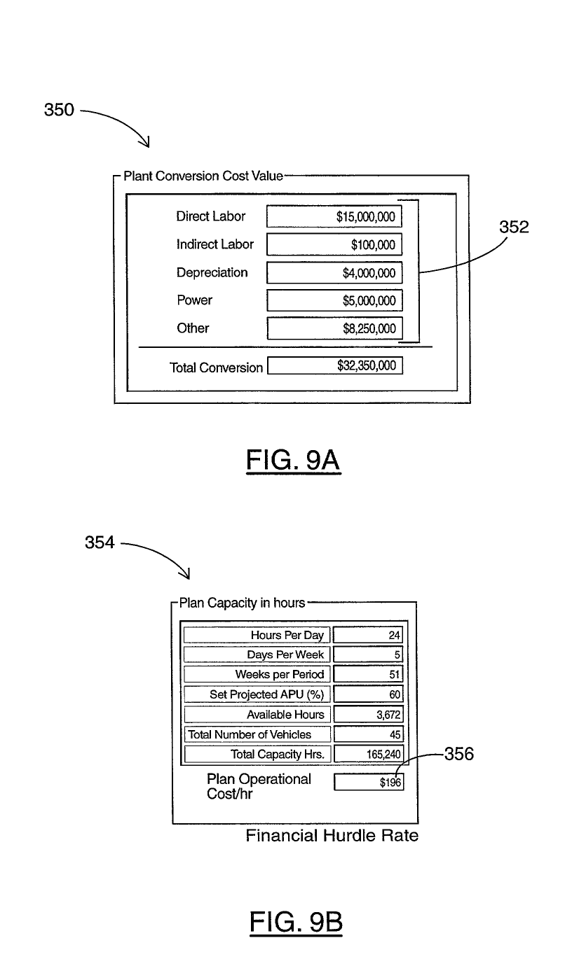

Referring to FIG. 9A, a screen capture of a dialog box 350 in which a user can enter conversion costs 352 is shown. Conversion costs may be entered at step 120 of FIG. 3A, with default values displayed as originally input at step 110 of FIG. 3A.

Referring to FIG. 9B, a screen capture of a dialog box 354 is illustrated, where a profit target hurdle rate 356 is displayed. Dialog box 354 may be generated at step 140 of FIG. 3A.

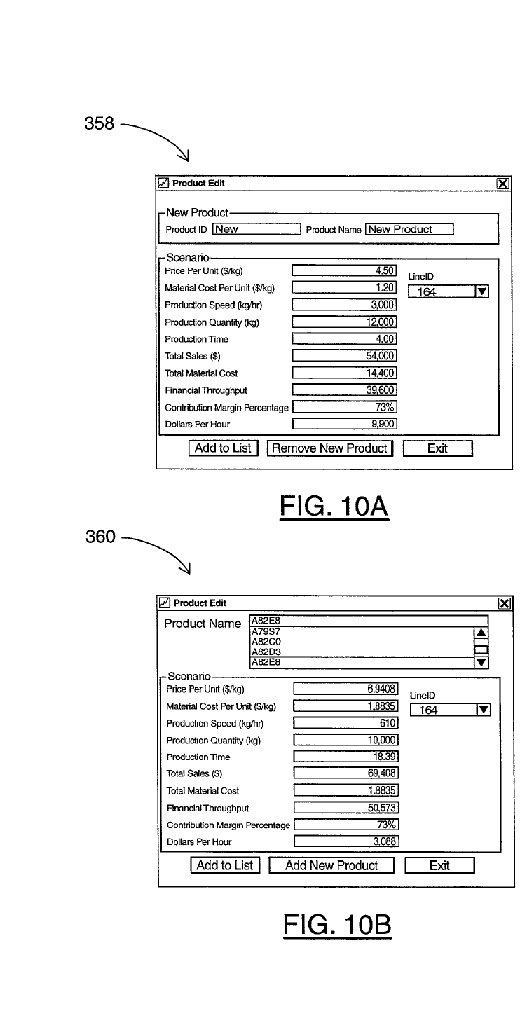

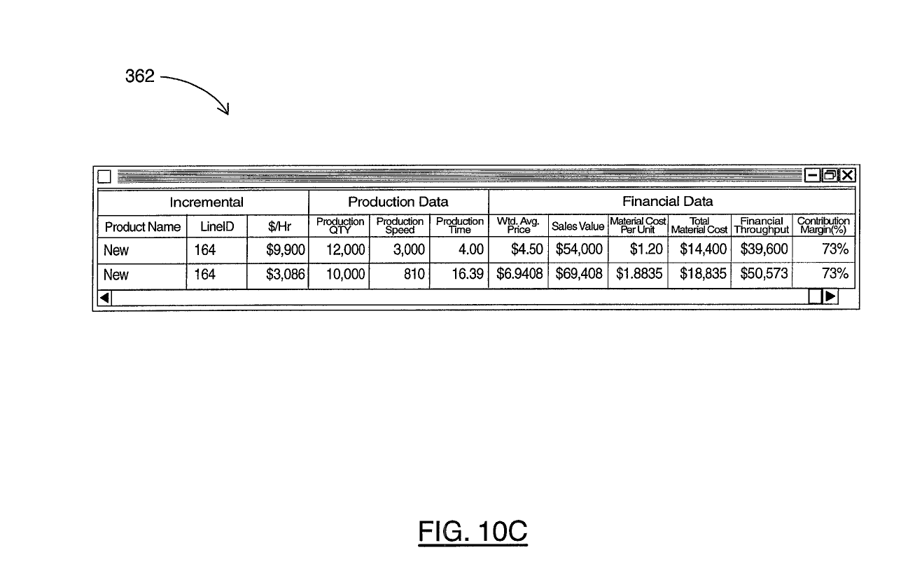

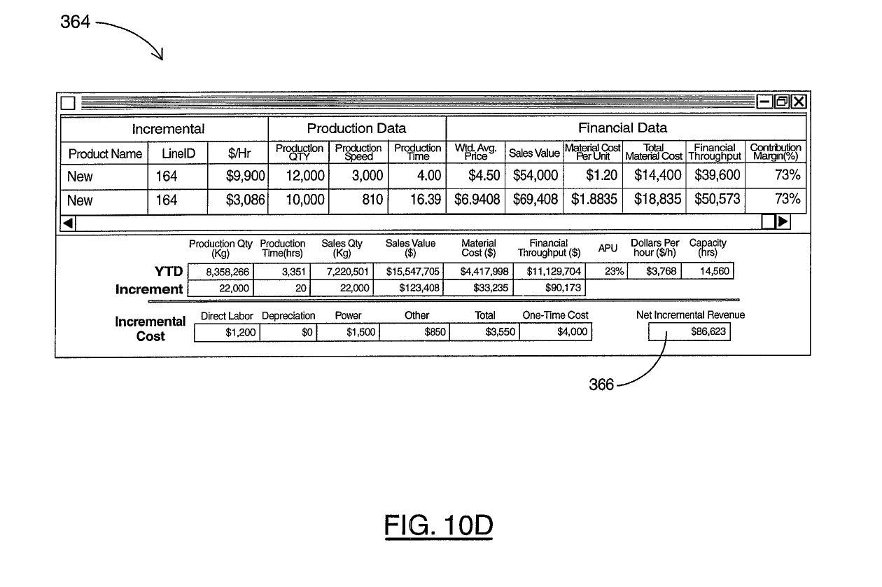

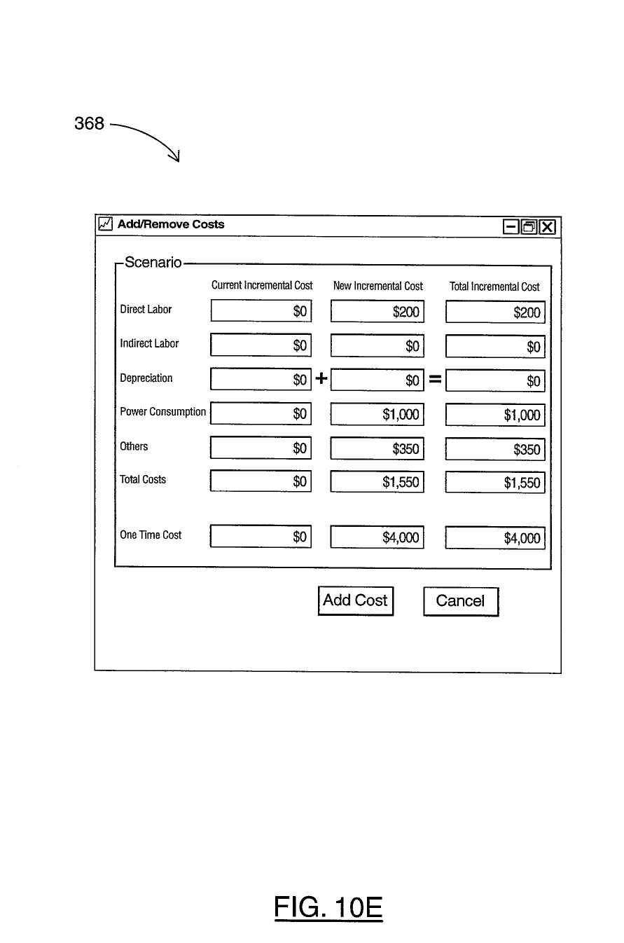

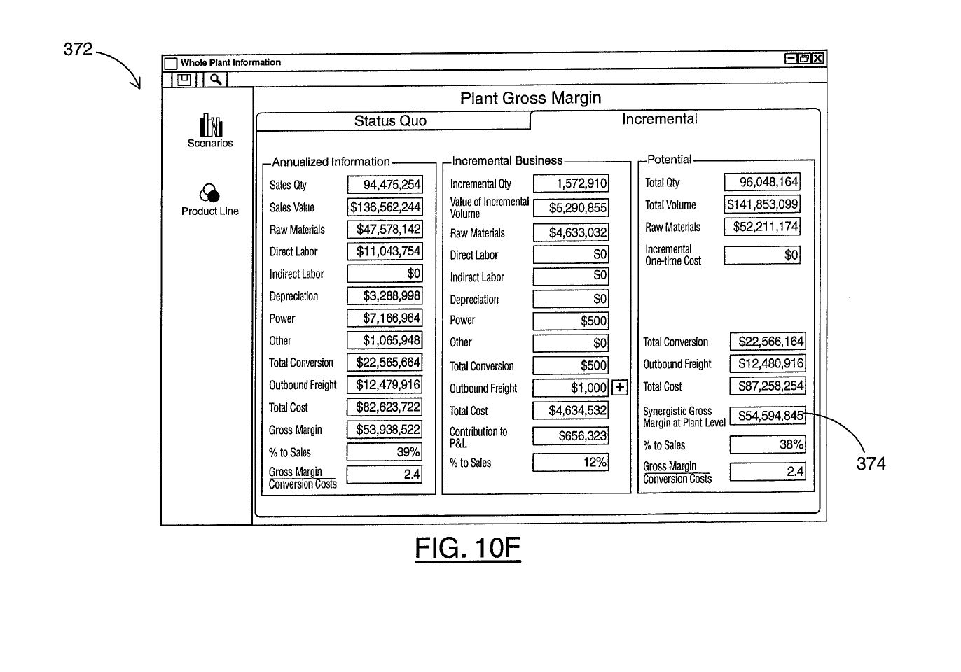

Referring to FIGS. 10A to 10E, example screens generated in a method of scenario-based analysis are illustrated. FIG. 10A is a screen capture of a control box 358 where projected performance measures are calculated and displayed for a proposed addition of a new product. Control box 358 may be displayed at step 258 of FIG. 4.

FIG. 10B is a screen capture of a control box 360 where projected performance measures are calculated and displayed for a proposed increase in production of an existing product. Control box 360 may also be displayed at step 258 of FIG. 4.

FIG. 10C is a screen capture of a summary screen 362 in which the calculated projected performance measures are displayed. Summary screen 362 may also be displayed at step 258 of FIG. 4.

FIG. 10D is a screen capture of an output screen 364 where the values of various projected performance measures are displayed, as well as a measure of net incremental revenue 366. Output screen 364 may be displayed at step 262 of FIG. 4.

FIG. 10E is a screen capture of a dialog box 368 where additional incremental conversion costs may be entered by a user. Dialog box 368 may be displayed at step 262 of FIG. 4.

FIG. 10F is a screen capture of a screen 372 which shows the user the effect of changes to conversion costs on the projected gross margin 374 of a plant. Screen 372 may be displayed at step 264 of FIG. 4.

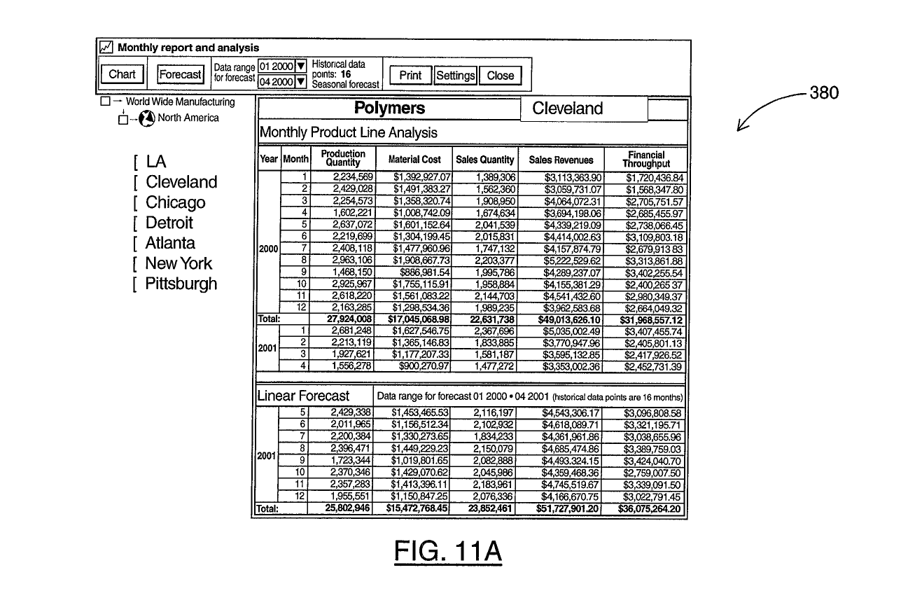

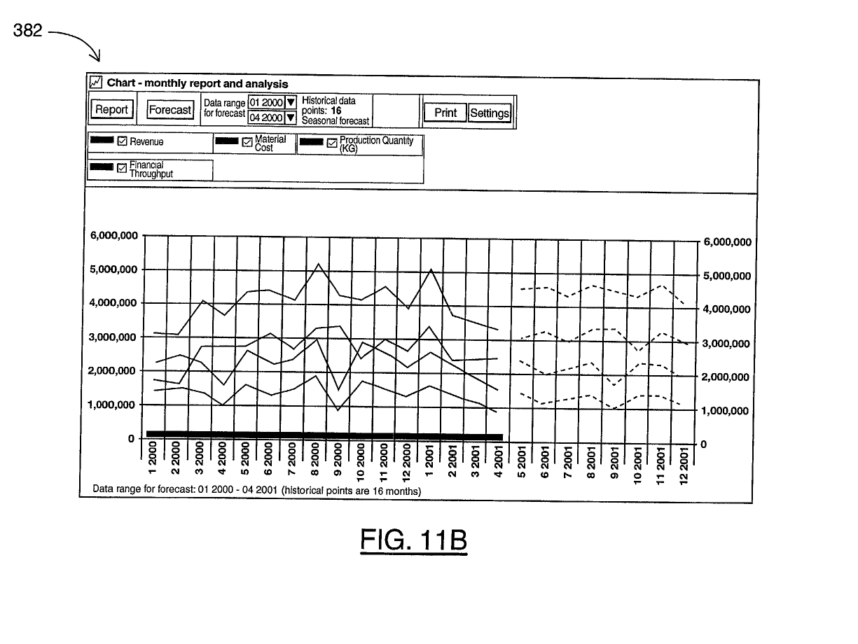

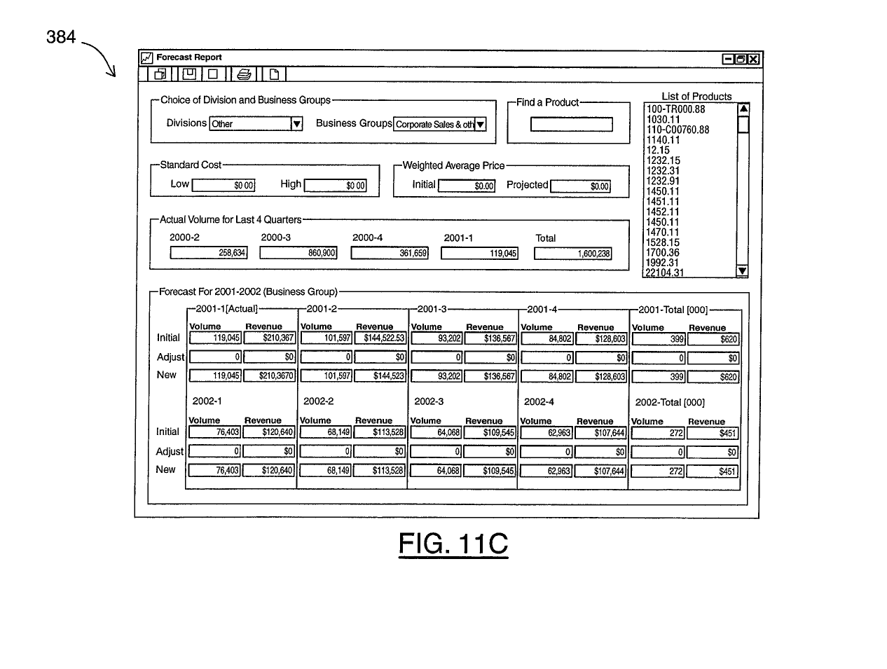

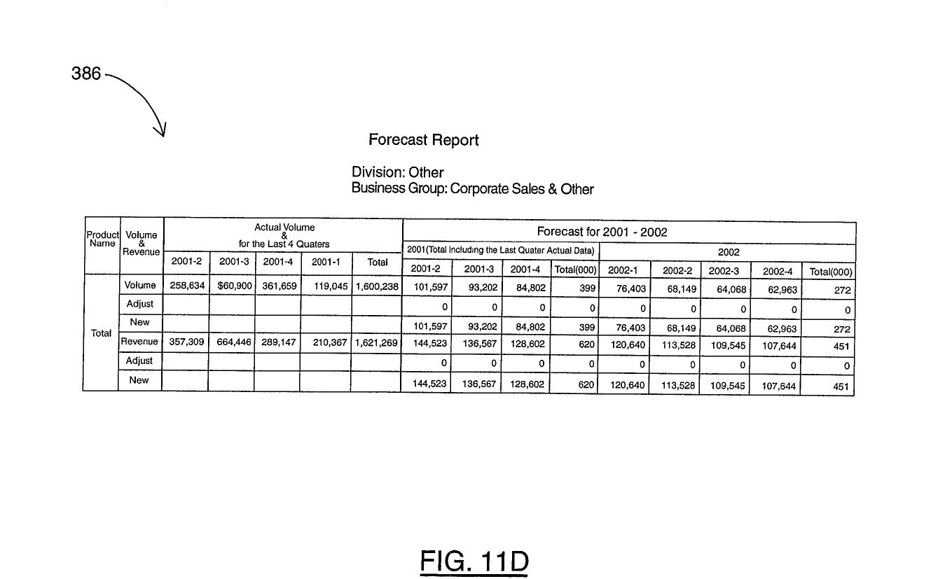

Referring to FIGS. 11A and 11B, shown are screen captures of output screens 380, 382, illustrating examples of output from a forecasting analysis, both in a tabular form and graphical form respectively. Output screens 380, 382 may be generated at step 278 of FIG. 5.

FIG. 11C is a screen capture of a screen 384 where a user may change generated forecasted values and other values used in the forecast (e.g. weighted average price), and FIG. 11D is an example of a generated forecast report 386. Screen 384 and report 386 may be generated at step 280 of FIG. 5.

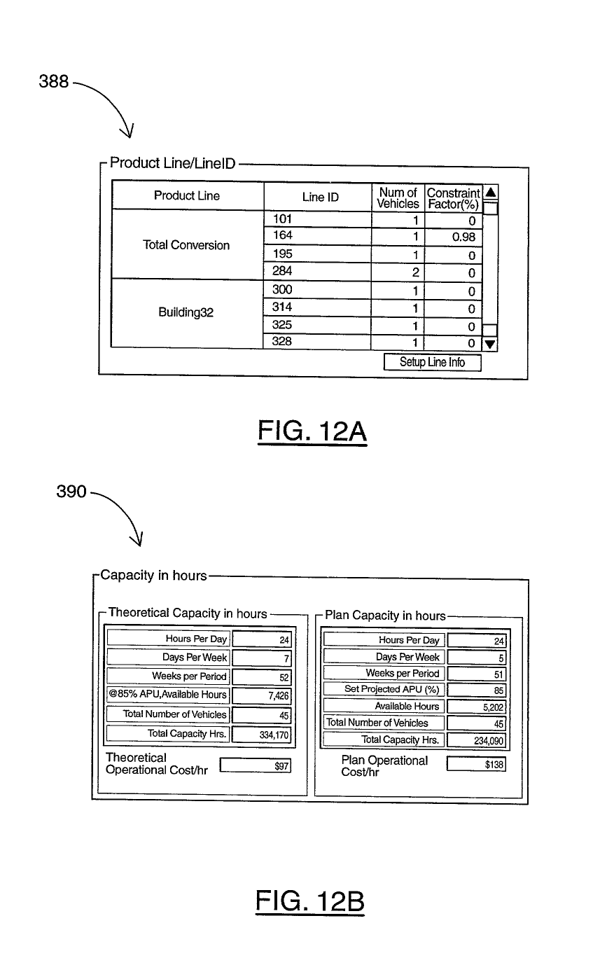

Referring to FIGS. 12A and 12B, screen capture of control boxes 388, 390 are shown, illustrating examples of output from a bottleneck analysis performed in an embodiment of the present invention. Constraints on different production lines can relating to the production of a product can be examined, and effect of changes in the planned available production time on operational costs can be assessed. Control boxes 388, 390 may be generated at step 296 and/or at step 300 of FIG. 6.

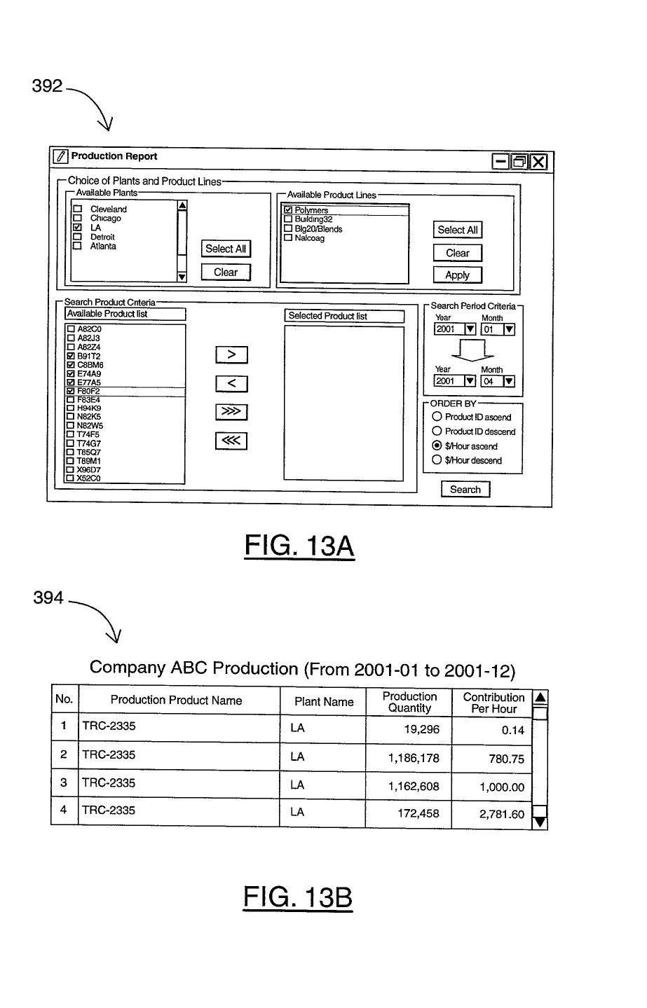

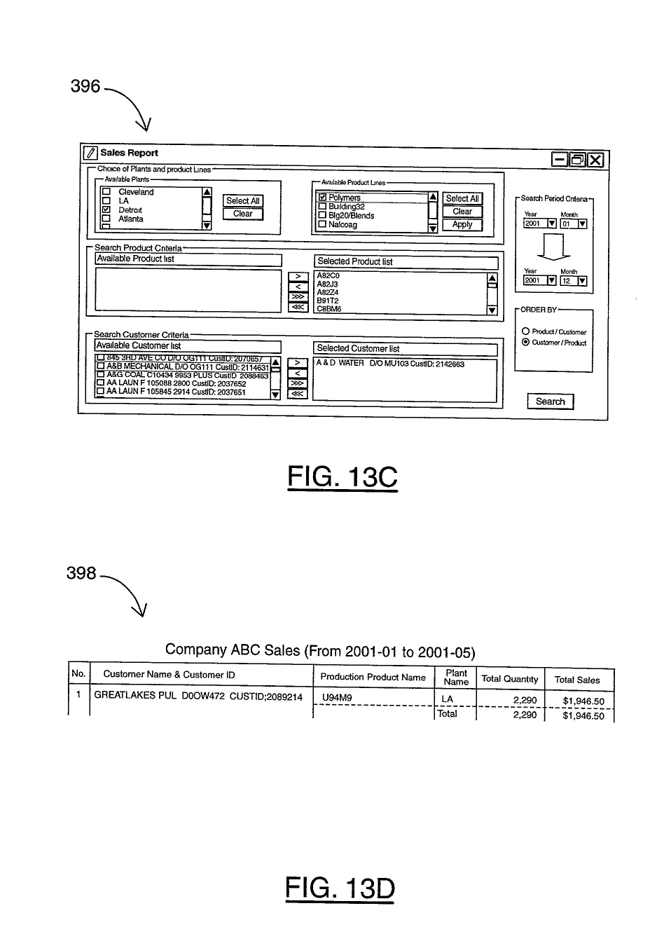

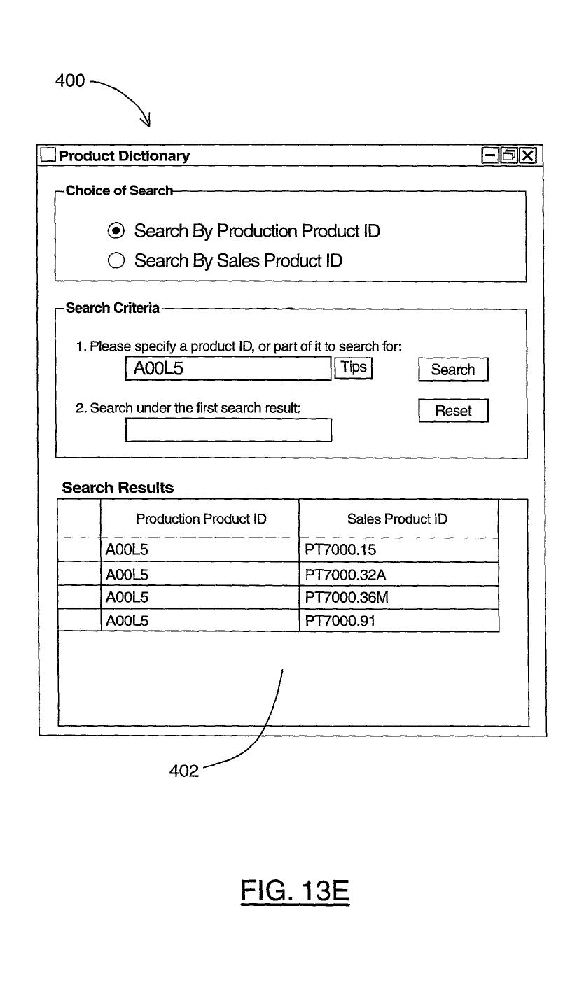

Referring to FIG. 13A, shown is a screen capture of a dialog box 392 used to generate a production report 394 such as the one illustrated in FIG. 13B, for example. Referring to FIG. 13C, shown is a screen capture of a dialog box 396 used to generate a sales report 398, such as the one illustrated in FIG. 13D, for example. FIG. 13E is a screen capture of a control box 400 where a user can input search criteria, and where output is displayed in a product dictionary report 402, also in control box 400. Production report 394, sales report 398, and production dictionary report 402 are examples of reports that may be generated at step 230 of FIG. 3B.

In variant embodiments of the present invention, it is possible to apply the techniques described to multiple plants. Data relating to one or more plants can be combined with data from one or more different plants, and performance and profitability measures can be calculated based on the consolidated data. This may allow a user to assess the desirability of merging plant operations, for example. Conversely, data relating to one or more plants can be filtered from data for multiple plants, and performance and profitability measures can be calculated based on the filtered data. This may allow a user to assess the desirability of eliminating plants from a group of plants being monitored as a group. Other methods of the present invention including scenario-based analysis, forecasting analysis, bottleneck analysis, and the generation of reports may also be applied to multiple plants, after data is consolidated or filtered as described above, for example. The user interface 70 of system 50 may also be designed to allow the user to “drag-and-drop plants” between input screens to facilitate easier consolidation of plant data, for the purposes of a scenario-based analysis or to determine the impact of a merger of multiple plants on profitability measures, for example.

In variant embodiments of the present invention, it will be obvious to those skilled in the art that there are numerous possible configurations of the user interface 70 and system 50 described herein, including adaptations to facilitate a web-based implementation of the present invention. Further modifications to the system 50 to permit secure access to information may be made in known manner. Firewalls may be implemented in system 50 to prevent unauthorized access to private information.

In variant embodiments of the present invention, components of application server 90 can be distributed across several servers, clients, terminals, machines, or other electronic devices. These may include one or more web servers if desired.

With respect to elements of the system 50, it will be apparent to those skilled in the art that the execution of various tasks associated with the present invention need not be performed by the particular component specified in the description of the preferred and variant embodiments of the invention. For example, it will be obvious to those skilled in the art that the performance of tasks by the processing modules 80 may be performed by a single module or by multiple different modules, which may or may not be associated with a single application, and which may or may not reside on the same server, client, terminal, machine, or other electronic device. As a further example, it will also be obvious to those skilled in the art that the information stored in the system databases 60 may be combined into a single database, or distributed across multiple storage means, which may or may not reside on the same server, client, terminal, machine, or other electronic device, and which may or may not be directly linked.

While the present invention, in its preferred embodiments, relate to the monitoring of the profitability of manufacturing organizations and manufacturing plants, the present invention may be applied to other organizations and industries in which goods and/or services are produced. Any organization that produces a product may utilize the present invention to change a method of producing a product based on a margin-based accounting model, to a method of producing a product based on a profitability-based accounting model.

The present invention has been described with regard to preferred embodiments. However, it will also be obvious to persons skilled in the art that a number of variants and modifications can be made without departing from the scope of the invention as described herein.

1. A computer-based method of monitoring the profitability of a manufacturing plant, the method comprising the steps of:
(a) storing a first plurality of data items in one or more system databases, said first plurality of data items comprising system setup data;
(b) receiving a second plurality of data items from at least one data source, said second plurality of data items comprising input data associated with a plurality of time periods;
(c) calculating a plurality of profitability measures from said first and second plurality of data items; and
(d) outputting one or more of said plurality of profitability measures to a user.

2. The computer-based method of monitoring the profitability of a manufacturing plant as claimed in claim 1, wherein said system setup data comprises conversion cost data, production line capacity data, and plant-level operating capacity data.

3. The computer-based method of monitoring the profitability of a manufacturing plant as claimed in claim 2, wherein said conversion cost data comprises one or more of the following: labor cost data, depreciation cost data, power consumption cost data, freight cost data, and other cost data.

4. The computer-based method of monitoring the profitability of a manufacturing plant as claimed in claim 3, wherein said labor cost data includes one or more of the following: direct labor cost data, indirect support labor cost data, indirect maintenance labor cost data, and salaried labor cost data.

5. The computer-based method of monitoring the profitability of a manufacturing plant as claimed in claim 3, wherein said conversion cost data is determined at a plant level and at a production line level.

6. The computer-based method of monitoring the profitability of a manufacturing plant as claimed in claim 2, wherein said production line capacity data comprises an indication of the number of production lines being monitored and other production line data.

7. The computer-based method of monitoring the profitability of a manufacturing plant as claimed in claim 6, wherein said other production line data comprises one or more of the following: production speed data, equipment availability data, and external constraints data.

8. The computer-based method of monitoring the profitability of a manufacturing plant as claimed in claim 2, wherein said operating capacity data comprises a planned available production time, wherein said planned available production time is calculated from: an indication of the number of hours per day that a plant is expected to be operational, an indication of the number of days per week that a plant is expected to be operational, and an indication of the number of weeks per pre-determined planning period that a plant is expected to be operational, and other factors affecting a plant's available production time.

9. The computer-based method of monitoring the profitability of a manufacturing plant as claimed in claim 1, wherein a data source is one of the following: a user through a user interface, a database, a data stream, a data file, and a computer-readable medium.

10. The computer-based method of monitoring the profitability of a manufacturing plant as claimed in claim 9, wherein said second plurality of data items comprises at least one of the following: customer data, product data, production data, sales data, profit/loss data, and target profit data.

11. The computer-based method of monitoring the profitability of a manufacturing plant as claimed in claim 10, wherein said plurality of time periods comprises a series of months.

12. The computer-based method of monitoring the profitability of a manufacturing plant as claimed in claim 2, wherein each of said plurality of profitability measures is one of the following: a measure of product profit velocity, a measure of target productive uptime, a measure of actual productive uptime, a measure of profit target hurdle rate, a measure of financial throughput, and a composite profitability measure.

13. The computer-based method of monitoring the profitability of a manufacturing plant as claimed in claim 12, wherein said measure of product profit velocity is calculated by dividing the difference between total revenue and total material cost associated with the production of a specified quantity of a product by the total time required to produce said specified quantity.

14. The computer-based method of monitoring the profitability of a manufacturing plant as claimed in claim 12, wherein said measure of target productive uptime is equal to a planned available production time, wherein said planned available production time is calculated from: an indication of the number of hours per day that a plant is expected to be operational, an indication of the number of days per week that a plant is expected to be operational, an indication of the number of weeks per pre-determined planning period that a plant is expected to be operational, and other factors affecting a plant's available production time.

15. The computer-based method of monitoring the profitability of a manufacturing plant as claimed in claim 12, wherein said measure of actual productive uptime is calculated by dividing the amount of time a production line is operational in producing quality product by a planned available production time, wherein said planned available production time is calculated from: an indication of the number of hours per day that a plant is expected to be operational, an indication of the number of days per week that a plant is expected to be operational, an indication of the number of weeks per pre-determined planning period that a plant is expected to be operational, and other factors affecting a plant's available production time.

16. The computer-based method of monitoring the profitability of a manufacturing plant as claimed in claim 12, wherein said measure of profit target hurdle rate is calculated by dividing the sum of costs associated with said manufacturing plant and a target profit by a planned available production time, wherein said planned available production time is calculated from: an indication of the number of hours per day that a plant is expected to be operational, an indication of the number of days per week that a plant is expected to be operational, an indication of the number of weeks per pre-determined planning period that a plant is expected to be operational, and other factors affecting a plant's available production time.

17. The computer-based method of monitoring the profitability of a manufacturing plant as claimed in claim 12, wherein said measure of financial throughput is calculated by subtracting total material cost associated with a specified quantity of a product by total revenue associated with said specified quantity.

18. The computer-based method of monitoring the profitability of a manufacturing plant as claimed in claim 12, wherein said measure of financial throughput is calculated by dividing the difference in total material cost associated with a specified quantity of a product and total revenue associated with said specified quantity by said specified quantity.

19. The computer-based method of monitoring the profitability of a manufacturing plant as claimed in claim 12, wherein said composite profitability measure is a function of one or more of the following: a measure of product profit velocity, a measure of target productive uptime, a measure of actual productive uptime, a measure of profit target hurdle rate, and a measure of financial throughput.

20. The computer-based method of monitoring the profitability of a manufacturing plant as claimed in claim 1, wherein said method further comprises the steps of:
(e) retrieving actual production data associated with a specified period;
(f) obtaining scenario data from said user, wherein said scenario data comprises data items associated with a proposed change in production;
(g) calculating a plurality of projected performance measures associated with said proposed change in production; and
(h) outputting one or more of said plurality of projected performance measures to said user.

21. The computer-based method of monitoring the profitability of a manufacturing plant as claimed in claim 20, wherein said specified period is a prior fiscal year.

22. The computer-based method of monitoring the profitability of a manufacturing plant as claimed in claim 20, wherein said proposed change in production is an addition of a new product to a specified production line.

23. The computer-based method of monitoring the profitability of a manufacturing plant as claimed in claim 22, wherein said scenario data comprises one or more of the following: a price, a material cost, a production speed, and a production quantity.

24. The computer-based method of monitoring the profitability of a manufacturing plant as claimed in claim 20, wherein said proposed change in production is an increase in production of a specified existing product.

25. The computer-based method of monitoring the profitability of a manufacturing plant as claimed in claim 24, wherein said scenario data comprises a price and a production quantity.

26. The computer-based method of monitoring the profitability of a manufacturing plant as claimed in claim 20, wherein said projected performance measures comprise one or more of the following: production time, total sales, total material cost, financial throughput, APU, contribution margin as a percentage, and contribution dollars per hour.

27. The computer-based method of monitoring the profitability of a manufacturing plant as claimed in claim 20, wherein said method further comprises the step of:
(i) repeating steps (e) through (h) for zero or more additional proposed changes in production.

28. The computer-based method of monitoring the profitability of a manufacturing plant as claimed in claim 27, wherein said method further comprises the steps of:
(j) calculating a net incremental revenue; and
(k) outputting said net incremental revenue to said user.

29. The computer-based method of monitoring the profitability of a manufacturing plant as claimed in claim 28, wherein said method further comprises the steps of:
(l) receiving as input from said user one or more measures of incremental conversion costs associated with at least one of said proposed changes in production; and
(m) calculating an incremental contribution to gross margin, wherein said calculating step incorporates at least one of said proposed changes in production.

30. The computer-based method of monitoring the profitability of a manufacturing plant as claimed in claim 29, wherein said method further comprises the step of re-calculating at least one of said projected performance measures and net incremental revenue based on the changes to incremental conversion costs as determined by the input received in step (1).

31. The computer-based method of monitoring the profitability of a manufacturing plant as claimed in claim 1, wherein said method further comprises the steps of:
(e) receiving as input a third plurality of data items, wherein said third plurality of data items represent historical production data;
(f) calculating historical values from said third plurality of data items, wherein said historical values comprise the values of a plurality of user-specified measures associated with one or more historical periods; and
(g) forecasting future values based on said historical values, wherein said future values comprise the values of a plurality of user-specified measures associated with one or more future periods.

32. The computer-based method of monitoring the profitability of a manufacturing plant as claimed in claim 31, wherein said forecasting step comprises the use of straight-line forecasting techniques.

33. The computer-based method of monitoring the profitability of a manufacturing plant as claimed in claim 31, wherein said forecasting step comprises the use of seasonally adjusted forecasting techniques.

34. The computer-based method of monitoring the profitability of a manufacturing plant as claimed in claim 31, wherein each of said plurality of user-specified measures is one of the following: production quantity, material cost, revenue, freight cost, financial throughput, and sales quantity.

35. The computer-based method of monitoring the profitability of a manufacturing plant as claimed in claim 31, wherein said at least of said historical values and said future values are displayed to said user in at least one of a tabular format and a graphical format.

36. The computer-based method of monitoring the profitability of a manufacturing plant as claimed in claim 31, wherein said method further comprises the steps of receiving changes to said future values from a user, and re-forecasting said future values incorporating said changes.

37. The computer-based method of monitoring the profitability of a manufacturing plant as claimed in claim 1, wherein said method further comprises the steps of:
(e) calculating from said first and second plurality of data items, a measure of maximum planned throughput for a piece of equipment;
(f) comparing said measure of maximum planned throughput to current production levels; and
(g) indicating the presence of a bottleneck to said user if current production levels exceed said measure of maximum planned throughput.

38. The computer-based method of monitoring the profitability of a manufacturing plant as claimed in claim 37, wherein said method further comprises the steps of:
(h) comparing said measure of maximum planned throughput to current sales levels; and
(i) indicating the presence of a potential bottleneck to said user if said current sales levels are substantially equal to said maximum planned throughput.

39. The computer-based method of monitoring the profitability of a manufacturing plant as claimed in claim 38, wherein said method further comprises the step of indicating to the user constraints on production lines associated with a bottleneck or potential bottleneck.

40. The computer-based method of monitoring the profitability of a manufacturing plant as claimed in claim 1, wherein said method further comprises the step of generating one or more reports to a user based on said first and second plurality of data items.

41. The computer-based method of monitoring the profitability of a manufacturing plant as claimed in claim 40, wherein said one or more reports comprise one or more of the following: a production report, a sales report, a product dictionary report, and a forecast report.

42. The computer-based method of monitoring the profitability of a manufacturing plant as claimed in claim 41, wherein said production report displays a measure of contribution per hour of one or more products.

43. The computer-based method of monitoring the profitability of a manufacturing plant as claimed in claim 41, wherein said sales report displays sales information associated with one or more customers.

44. The computer-based method of monitoring the profitability of a manufacturing plant as claimed in claim 41, wherein said product dictionary report displays sales names for a product associated with said product's manufacturing name.

45. The method of analyzing the future profitability of an entity using scenario-based analysis, comprising the steps of:
(a) retrieving actual production data from a specified period;
(b) obtaining scenario data from said user, wherein said scenario data comprises data items associated with a proposed change in production;
(c) calculating a plurality of projected performance measures associated with said proposed change in production; and
(d) outputting one or more of said plurality of projected performance measures to said user.

46. The method of analyzing the future profitability of an entity using scenario-based analysis as claimed in claim 45, wherein said specified period is a prior fiscal year.

47. The method of analyzing the future profitability of an entity using scenario-based analysis as claimed in claim 45, wherein said proposed change in production is an addition of a new product to a specified production line.

48. The method of analyzing the future profitability of an entity using scenario-based analysis as claimed in claim 47, wherein said scenario data comprises one or more of the following: a price, a material cost, a production speed, and a production quantity.

49. The method of analyzing the future profitability of an entity using scenario-based analysis as claimed in claim 45, wherein said proposed change in production is an increase in production of a specified existing product.

50. The method of analyzing the future profitability of an entity using scenario-based analysis as claimed in claim 49, wherein said scenario data comprises a price and a production quantity.

51. The method of analyzing the future profitability of an entity using scenario-based analysis as claimed in claim 45, wherein said projected performance measures comprise one or more of the following: production time, total sales, total material cost, financial throughput, APU, contribution margin as a percentage, and contribution dollars per hour.

52. The method of analyzing the future profitability of an entity using scenario-based analysis as claimed in claim 45, further comprising the step of:
(e) repeating steps (a) through (d) for zero or more additional proposed changes in production.

53. The method of analyzing the future profitability of an entity using scenario-based analysis as claimed in claim 52, further comprising the steps of:
(f) calculating a net incremental revenue; and
(g) outputting said net incremental revenue to said user.

54. The method of analyzing the future profitability of an entity using scenario-based analysis as claimed in claim 53, further comprising the steps of:
(h) receiving as input from said user one or more measures of incremental conversion costs associated with at least one of said proposed changes in production; and
(i) calculating an incremental contribution to gross margin, wherein said calculating step incorporates at least one of said proposed changes in production.

55. The method of analyzing the future profitability of an entity using scenario-based analysis as claimed in claim 54, further comprising the step of re-calculating at least one of said projected performance measures and net incremental revenue based on the changes to incremental conversion costs as determined by the input received in step (h).

56. A system for monitoring the profitability of a manufacturing plant, said system comprising:
a) one or more system databases;
b) a data source interface connected to said system databases;
c) a user interface; and
d) one or more processing modules connected to said system databases, said data source interface and said user interface, wherein said processing modules are programmed to perform the following steps:
i) storing a first plurality of data items in one or more system databases, said first plurality of data items comprising system setup data;
ii) receiving a second plurality of data items from at least one data source, said second plurality of data items comprising input data associated with a plurality of time periods;
iii) calculating a plurality of profitability measures from said first and second plurality of data items; and
iv) outputting one or more of said plurality of profitability measures to a user.

57. A system for monitoring the profitability of a manufacturing plant, said system comprising:
a) one or more system databases;
b) a data source interface connected to said system databases;
c) a user interface; and
d) one or more processing modules connected to said system databases, said data source interface and said user interface, wherein said processing modules are programmed to perform the following steps:
(i) retrieving actual production data from a specified period;
(ii) obtaining scenario data from said user, wherein said scenario data comprises data items associated with a proposed change in production;
(iii) calculating a plurality of projected performance measures associated with said proposed change in production; and
(iv) outputting one or more of said plurality of projected performance measures to said user.

58. A computer-readable medium comprising instructions for executing the steps of:
a) storing a first plurality of data items in one or more system databases, said first plurality of data items comprising system setup data;
b) receiving a second plurality of data items from at least one data source, said second plurality of data items comprising input data associated with a plurality of time periods;
c) calculating a plurality of profitability measures from said first and second plurality of data items; and
d) outputting one or more of said plurality of profitability measures to a user.

59. A computer-readable medium comprising instructions for executing the steps of:
(a) retrieving actual production data from a specified period;
(b) obtaining scenario data from said user, wherein said scenario data comprises data items associated with a proposed change in production;
(c) calculating a plurality of projected performance measures associated with said proposed change in production; and
(d) outputting one or more of said plurality of projected performance measures to said user.
